(19) United States
(12) Patent Application Publication
(10) Pub. No.: US 2001/0052518 A1
(43) Pub. Date: Dec. 20, 2001

(54) Air heater

(76) Inventor: Klaus Neckel, Spielberg (DE)

Correspondence Address: NIXON PEABODY, LLP, 8180 GREENSBORO DRIVE, SUITE 800, MCLEAN, VA, 22102, US

(21) Appl. No.: 09/879,080

(22) Filed: Jun. 13, 2001

(30) Foreign Application Priority Data
Jun. 14, 2000 (DE) 100 28 446.9-34

(51) Int. Cl. H05B 3/00

(52) U.S. Cl. 219/505; 392/485

(57) ABSTRACT

Air heater with PTC heating element with semiconductor switch, the semiconductor switch (5) without the housing being located in the heating tube (9) in the immediate vicinity of the PTC heating element (15).

The invention relates to an air heater as claimed in the preamble of claim 1.

Air heaters with PTC heating elements which are pushed into the air conditioning box of a motor vehicle and which are connected to a semiconductor switch are known.

Standardized HL switches are installed in their own housing, the switches being located at a great spatial distance to the coolant. Power loss in the form of heat occurs due to the internal resistance of the HL switch. It is conventional to route this power loss at the same time into the medium which is to be heated by the heating element. As a result of the great spatial distance numerous material transitions occur over long transport distances so that overall the heat transfer resistance is relatively great. For these reasons high-power HL switches must be used.

The object of the invention is to make available air heaters, circumventing the indicated defects, in which the heat transfer resistance is improved between the HL switch and the coolant, i.e. reduced, with the objective of being able to use lower power HL switches.

The object as claimed in the invention is achieved by the air heater as claimed in claim 1. Other advantageous embodiments of the air heater as claimed in the invention derive from the following claims 2 to 4.

One important aspect is to use only a switch chip, not a standardized HL switch in its own housing. By placing this chip (only the silicon board) directly in the heating element the power loss can be drained directly into the coolant. Additional heat conductors are not needed. Installation is simple.

In addition, lower power HL switches can be used. At the same time the heat loss of the HL switch is dissipated completely as heat output to the medium to be heated (conventionally air).

By integration of the HL switch directly into the heat sink of the heating element the heat transfer between the switch and coolant is clearly reduced, the space required for the HL switch is clearly reduced and the mechanical structure of the heating element with electronic triggering is made more favorable in terms of production technology and cost.

The invention is detailed using the following FIGS. 1 to 5.

Here FIG. 1 is a schematic lengthwise section through the unit as claimed in the invention with a carrier material, HL chip and contact-making surfaces;

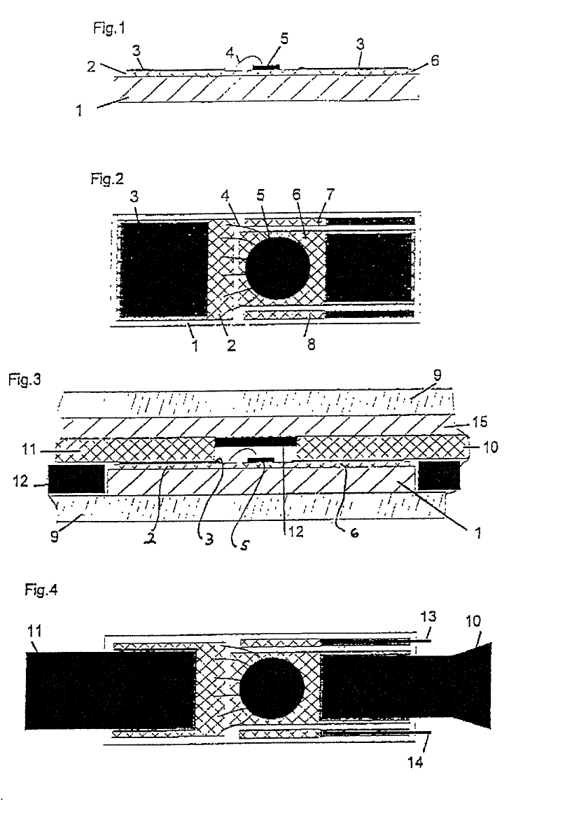

FIG. 2 shows a top view of the unit as shown in FIG. 1;

FIG. 3 is a schematic lengthwise section through the heating element with an integrated unit as claimed in the invention;

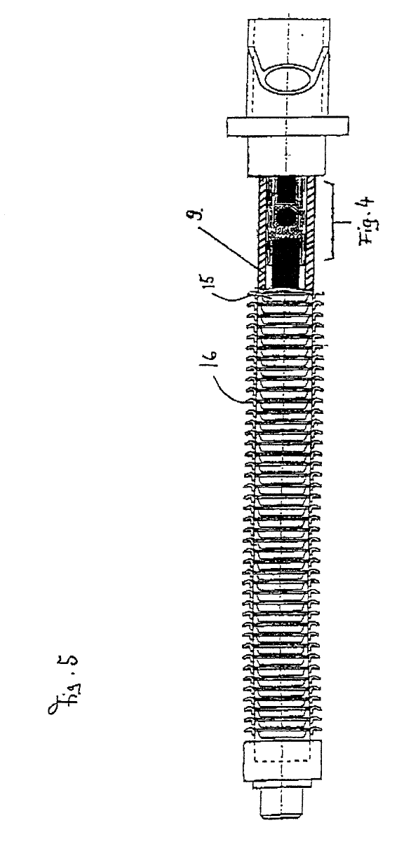

FIG. 4 shows a top view of the unit as shown in FIG. 2 with the contacts in place;

FIG. 5 shows a schematic lengthwise section through one embodiment of an air heater as claimed in the invention.

As shown in FIGS. 1 and 2 a HL switch chip 5 (only the silicon board) is used. The chip 5 is applied to a good heat conductor 6 (preferably copper). From there it is connected to the current output path 2 which makes contact with the PTC elements (ceramic) which yield the actual heat output; a further connection takes place to the control pad 7 and the diagnosis pad 8, the connection taking place preferably in bond technology. All these pads are good heat conductors, preferably copper, in order to be able to efficiently dissipate the heat introduced via connecting lines if necessary.

The pads are applied to an electrically nonconductive heat conductor 1 which preferably consists of ceramic.

A contact material 3 is applied to the pads and it ensures that the thermal and electrical contact resistance to the contact strips 10, which leads to the battery terminal, 11, which leads to the heating element, 13 (for the control pad 7), 14 (for diagnosis pad 8) are minimized accordingly.

As shown in FIG. 4 contact strips 10, 11, 13 which as control strips and 14, which is made as diagnosis strips, which are made of a good heat conductor, preferably copper, are placed over the pads 2, 6, 7, 8 (see FIG. 2).

This modular version is shown schematically as a top view in FIG. 2; here the formation of the current output pad 2 with the overlying contact material 3 is shown; the chip 5 is connected to the output pad 2, the control pad 7 and the diagnosis pad 8 which for their part are each occupied by contact material 3.

As shown in FIG. 3, the contact strips 10, 11, 13, 14 are placed on the contact material 3 via the pads 2, 6, 7, and 8, the installation of the module taking place by means of a frame 12; here it becomes clear that as a cover which closes to the top another electrically nonconductive heat conduction layer (ceramic) 15 rests on the contact strips 10/11, 13, 14. The modular unit is then placed in the heating rod 9 and pressed so that good heat transfer is ensured.

FIG. 4 finally shows as a schematic top view the modular unit with the contacts in place, the reference numbers having the aforementioned meaning.

FIG. 5 schematically shows one embodiment of an air heater as claimed in the invention, the modular unit as claimed in the invention being located within the aluminum tube 9 on its terminal-side area and being connected directly to the adjacent PTC heating elements 15; the heat output of the HL switch module and PTC elements 15 is dissipated to the environment via plates 16.

1. Air heater with PTC heating elements with semiconductor switch, wherein the semiconductor chip (5) without a housing is located in the heating tube (9) in the immediate vicinity of the PTC heating elements (15).

2. Air heater as claimed in claim 1, wherein the unit has a semiconductor switch chip (5), the pertinent contact strips (10), (11), (13), (14), a current output pad (2), a control pad (7), and diagnosis pad (8) and electrically nonconductive heat conductors (1, 15) which enclose them.

3. Air heater as claimed in claim 2, wherein the HL switch chip (5) without a housing is applied to a heat-conductive plate (6); wherein the chip (5) is connected to the current output path (2), to the control pad (7) and to the diagnosis pad (8) preferably in bond technique, the pads being supported on an electrically nonconductive heat conductor (1), preferably of ceramic, to the pads a contact material (3) being applied on which the contact strips (11) to the PTC heating element, (10) to the battery (13) of the control strip and (14) of the diagnosis strip rest.

4. Modular unit for connection of air heaters, wherein the HL switch chip (5) is applied without a housing to a heat-conductive plate (6); wherein the chip (5) is connected to the current output path (2), to the control pad (7) and to the diagnosis pad (8) preferably in bond technique, the pads being supported on an electrically nonconductive heat conductor (1), preferably of ceramic, to the pads a contact material (3) being applied on which the contact strips (11) to the PTC heating element, (10) to the battery (13) of the control strip and (14) of the diagnosis strip rest.
